(19) United States
(12) Patent Application Publication
(10) Pub. No.: US 2014/0002740 A1
(43) Pub. Date: Jan. 2, 2014

(54) INFORMATION PROCESSING TERMINAL, INFORMATION PROCESSING SYSTEM, AND INFORMATION PROCESSING METHOD

(71) Applicant: Takanobu Mukaide, Tachikawa-shi (JP)

(72) Inventor: Takanobu Mukaide, Tachikawa-shi (JP)

(21) Appl. No.: 13/682,328

(22) Filed: Nov. 20, 2012

(30) Foreign Application Priority Data
Jun. 27, 2012 (JP) 2012-144214

(51) Int. Cl. H04N 21/41

(52) U.S. Cl. CPC H04N 21/4126
USPC 348/552

(57) ABSTRACT

According to one embodiment, an information processing terminal includes a selector, a receiver, and a transmitter. The selector is configured to select at least one of functions to incorporate in a first external apparatus, in accordance with a user's operation. The receiver is configured to download, from a second external apparatus, a program associated with selected functions. The transmitter is configured to transmit the program to the first external apparatus.

### CROSS-REFERENCE TO RELATED APPLICATIONS

This application is based upon and claims the benefit of priority from Japanese Patent Application No. 2012-144214, filed Jun. 27, 2012, the entire contents of which are incorporated herein by reference.

### FIELD

Embodiments described herein relate generally to an information processing terminal capable of customizing an external apparatus, an information processing system, and an information processing method.

### BACKGROUND

In recent years, digital television reception apparatuses have come to have more and more functions, such as an image-quality enhancement function and a sound-quality enhancement function. The digital television reception apparatus incorporates the image-quality enhancement function and sound-quality enhancement function when it is shipped from the manufacturer. The digital television reception apparatus is guaranteed to perform all its functions at the same time. For example, each function is adjusted not to exceed the data processing capabilities of the video processor and audio processor provided in the digital television reception apparatus. In other words, the functions are limited, in terms of specification, performance and processing load, so that they may operate at the same time.

In many cases, the digital television reception apparatus is used, with its various functions set when it was shipped from the manufacturer, because each function has many setting items.

By contrast, the mobile terminals, a representative example of which is the smart phone, is rarely used with its various functions set when it was shipped from the manufacturer. This is because the user adds various functions to it, in accordance with his or her taste.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram of an information processing system according to an embodiment;

FIG. 2 is an exemplary flowchart explaining an exemplary program acquisition process according to the embodiment;

FIG. 3 is an exemplary diagram showing a video/audio process function menu according to the embodiment;

FIG. 4 is an exemplary flowchart explaining an exemplary process of setting an external apparatus, according to the embodiment;

FIG. 5 is an exemplary flowchart explaining an exemplary process of transmitting a program, according to the embodiment; and

FIG. 6 is an exemplary flowchart explaining another exemplary process of transmitting a program, according to the embodiment.

### DETAILED DESCRIPTION

Various embodiments will be described hereinafter with reference to the accompanying drawings.

In general, according to one embodiment, an information processing terminal includes a selector, a receiver, and a transmitter. The selector is configured to select at least one of functions to incorporate in a first external apparatus, in accordance with a user's operation. The receiver is configured to download, from a second external apparatus, a program associated with selected functions. The transmitter is configured to transmit the program to the first external apparatus.

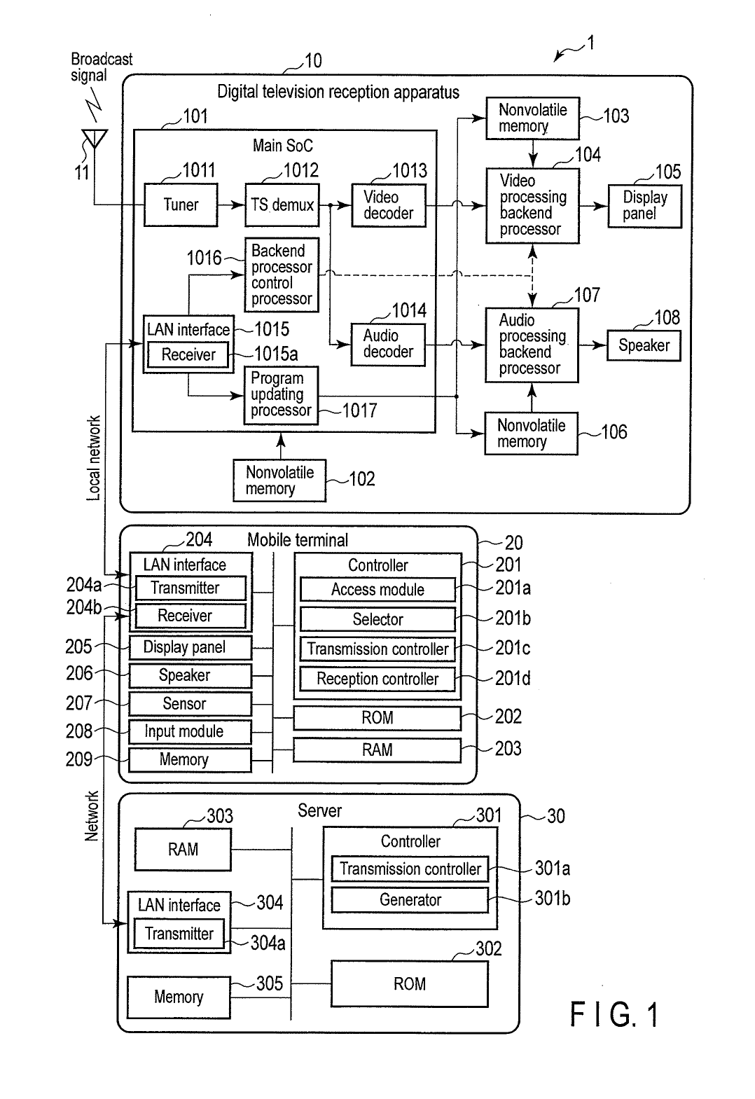

An embodiment will be described hereinafter with reference to the accompanying drawings. FIG. 1 is a block diagram showing an information processing system according to the embodiment. The information processing system comprises a digital television reception apparatus 10, a mobile terminal (information processing terminal) 20, and a server 30.

The configuration of the digital television reception apparatus (i.e., electronic apparatus) 10 will be de described. The digital television reception apparatus 10 comprises a main system-on-a-chip (SoC) 101, a nonvolatile memory 102, a nonvolatile memory 103, a video processing backend processor 104, a display panel 105, a nonvolatile memory 106, an audio processing backend processor 107, and a speaker 108.

The main SoC 101 comprises a tuner 1011, a transport stream demultiplexer (TS demux) 1012, a video decoder 1013, an audio decoder 1014, a local area network (LAN) interface 1015, a backend processor control processor 1016, and a program updating processor 1017. These components need not be incorporated in the main SoC 101. Rather, they may be provided outside main SoC 101.

The tuner 1011 receives a digital broadcast signal through an antenna 11, acquiring broadcast data from the signal. The tuner 1011 outputs the broadcast data to the TS demux 1012. The TS demux 1012 isolates audio data and audio data from the broadcast data. The TS demux 1012 outputs the video data to the video decoder 1013. Further, the TS demux 1012 outputs the audio data to the audio decoder 1014. The video decoder 1013 decodes video data, and outputs the video data to the video processing backend processor 104. The audio decoder 1014 decodes the audio data, and outputs the audio data to the audio processing backend processor 107.

The LAN interface 1015 is the transceiver that performs wireless communication with the mobile terminal 20. The LAN interface 1015 comprises a receiver 1015a, which is configured to receive information from the mobile terminal 20. The backend processor control processor 1016 receives a command addressed to the video processing backend processor 104, from the mobile terminal 20 through the LAN interface 1015. The backend processor control processor 1016 outputs the command to the video processing backend processor 104, as will be described later in detail. Similarly, the backend processor control processor 1016 receives a command addressed to the audio processing backend processor 107, from the mobile terminal 20 through the LAN interface 1015. The backend processor control processor 1016 outputs this command to the backend processor control processor 1016, as will be described later in detail. The program updating processor 1017 receives the program (hereinafter referred to as “video process program”) for use in the video processing backend processor 104, from the mobile terminal 20 through the LAN interface 1015. The program updating processor 1017 executes the video process program transmitted from the mobile terminal 20, and updates (or rewrites) the video process program stored in the nonvolatile memory 103. Similarly, the program updating processor 1017 receives the program (hereinafter referred to as “video process program”) for use in the audio processing backend processor 107, from the mobile terminal 20 through the LAN interface 1015. The program updating processor 1017 executes the video process program transmitted from the mobile terminal 20, and updates the audio process program stored in the nonvolatile memory 106. In the following description of the embodiment, a term of “video/audio process program” will be used, meaning the video process program, the audio process program or the combination of these programs.

The nonvolatile memory 102 stores the control programs, etc., which are used in the main SoC 101.

The nonvolatile memory 103 stores not only the video process program installed at the time of shipping the digital television reception apparatus 10, but also the video process program transmitted from the mobile terminal 20 as described above. The video processing backend processor 104 is a processor connected to the output of the main SoC 101. The video processing backend processor 104 uses the video process program stored in the nonvolatile memory 103, and performs, for example, an image-quality enhancement process on the video data. The video processing backend processor 104 outputs the video data subjected to the image-quality enhancement process, to the display panel 105. The display panel 10 displays the image represented by the video data.

The nonvolatile memory 106 stores not only the audio process program installed at the time of shipping the digital television reception apparatus 10, but also the audio process program transmitted from the mobile terminal 20 as described above. The audio processing backend processor 107 is a processor connected to the output of the main SoC 101. The audio processing backend processor 107 uses the audio process program stored in the nonvolatile memory 106, and performs, for example, a sound-quality enhancement process on the audio data. The audio processing backend processor 107 outputs the audio data subjected to the sound-quality enhancement process, to the speaker 108. The speaker 108 generates the sound represented by the audio data.

The embodiment hitherto described is the digital television reception apparatus 10. Instead, it may be an electronic apparatus comprising either a processor capable of processing video data or a processor capable of processing audio data.

The configuration of the mobile terminal 20 will be described. The mobile terminal 20 is an electronic apparatus that can perform communication with the digital television reception apparatus 10 and the server 30. The mobile terminal 20 is, for example, a smart phone or a tablet-type terminal.

The mobile terminal 20 comprises a controller 201, a read only memory (ROM) 202, a random access memory (RAM) 203, a LAN interface 204, a display panel 205, a speaker 206, a sensor 207, an input module 208, and a memory 209.

The controller 201 controls the other components of the mobile terminal 20. The controller 201 comprises an access module 201a, a selector 201b, a transmission controller 201c, and a reception controller 201d. The access module 201a is configured to make an access to the user interface the server 30 provides. The selector 201b is configured to operate the user interface server 30 provides. The transmission controller 201c is configured to transmit information to the digital television reception apparatus 10 or the server 30. The reception controller 201d is configured to receive information from the digital television reception apparatus 10 or the server 30. The ROM 202 stores the programs for controlling some components of the mobile terminal 20. The RAM 203 functions as work memory for the controller 201.

The LAN interface 204 is the transceiver that performs wireless communication with the digital television reception apparatus 10 and the server 30. The LAN interface 204 comprises a transmitter 204a configured to transmit information to the digital television reception apparatus 10 or the server 30. The LAN interface 204 comprises a receiver 204b configured to receive information from the server 30. The display panel 205 can display various images under the control of the controller 201. The speaker 206 generates sound as it is controlled by the controller 201. The sensor 207 includes an electrostatic capacitance sensor. The sensor 207 is formed integral with, for example, the display panel 205. The sensor 207 supplies, to the controller 201, the signals generated as the user performs an operation at the display panel 205. The input module 208 has, for example, button-like keys. The input module 208 supplies the signals generated as the keys are pressed, to the controller 201. The memory 209 stores various items of information.

The mobile terminal 20 configured as described above has the function of transferring (or transmitting) the video/audio process program downloaded from the server 30, to the digital television reception apparatus 10, and instructing the digital television reception apparatus to update the video/audio process program.

Further, the mobile terminal 20 has the function of instructing the digital television reception apparatus 10 to update the video/audio process program stored in the digital television reception apparatus 10, in accordance with the items the user has selected in the video/audio process function menu associated with the video/audio process program downloaded from the server 30.

The configuration of the server 30 will be described. The sever 30 comprises a controller 301, a ROM 302, a RAM 303, a LAN interface 304, and a memory 305.

The controller 301 controls the other components of the server 30. The controller 301 comprises a transmission controller 301a and a generator 301b. The transmission controller 301a is configured to transmit information to the mobile terminal 20. The generator 301b is configured to generate the video/audio process program and a setting menu. The ROM 302 stores the programs for controlling the components of the server 30. The RAM 303 functions as work memory for the controller 301. The LAN interface 304 is a transceiver that performs wireless communication with the mobile terminal 20. The LAN interface 304 comprises a transmitter 304a configured to transmit information to the mobile terminal 20. The memory 305 stores various items of information.

The server 30 configured as described above has the function of providing, if accessed by the mobile terminal 20, a user interface (hereinafter referred to as a “video/audio process function selection UI”) that the user may use to select any desired combination of video/audio process functions in the digital television reception apparatus 10. The video/audio process function selection UI as the controller 301 uses the program stored in the memory 305 and describing the video/audio process function selection UI. The term “video/audio process function” used in connection with the embodiment means any video process function the video processing backend processor 104 performs or any audio process function the audio processing backend processor 107 performs, or both, in the digital television reception apparatus 10. Further, the server 30 has a function of generating a setting menu for use in controlling the video/audio process program to implant the video/audio process functions the user has selected. In the setting menu, the functions described in the video/audio process program may be set independently of one another, or altogether at a time. Moreover, the server 30 has a function of transmitting the video/audio process program and the setting menu, it has generated, to the mobile terminal 20.

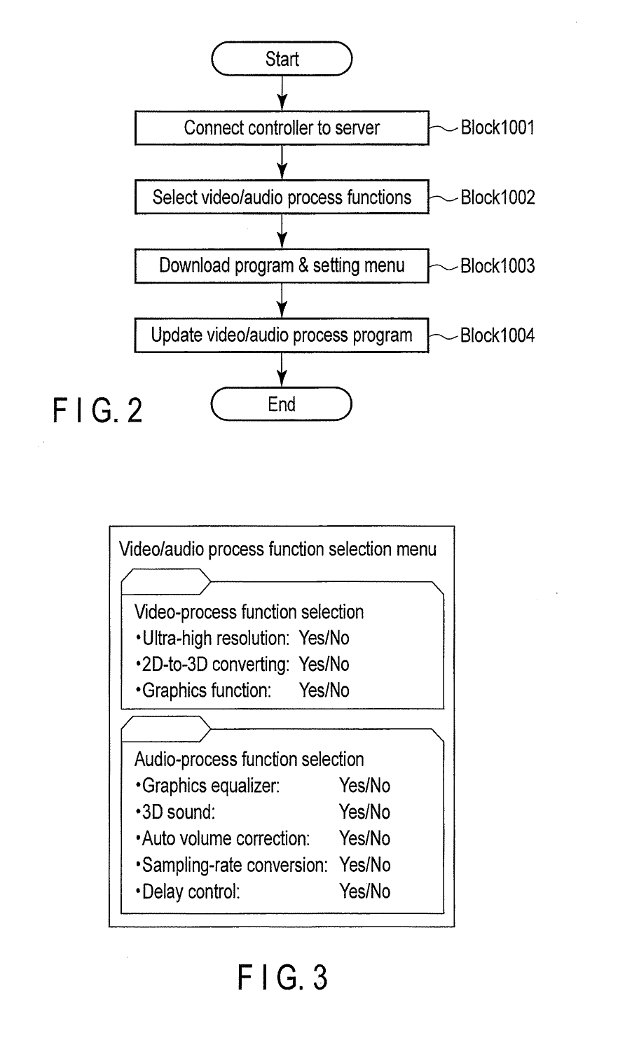

FIG. 2 is a flowchart explaining an exemplary method in which the mobile terminal 20 acquires the video/audio process program from the server 30.

The controller 201 of the mobile terminal 20 is connected to the server 30 in accordance with the signals the user has input at the input module 208 (Block 1001). More specifically, the controller 201 accesses, via the LAN interface 204, the video/audio process function selection UI the server 30 provides. The controller 201 then causes the display panel 205 to display the video/audio process function selection UI. On the video/audio process function selection UI thus displayed, the controller 201 selects, in accordance with the user's operation, the video/audio process functions that are incorporated in the digital television reception apparatus 10 (Block 1002).

FIG. 3 shows an example the video/audio process function selection UI, which may be displayed on the display panel 205 of the mobile terminal 20. As shown in FIG. 3, the video/audio process function selection UI has a video-process function selection column and an audio-process function selection column. The video-process functions may include, for example, an ultra-high resolution function, a 2D-to-3D conversion function, and a graphics function. Nonetheless, the video-process functions are not limited these. The audio-process functions may include, for example, a graphics equalizer, 3D sound, automatic volume correction, sampling-rate conversion and delay control. Nonetheless, the audio-process functions are not limited to these. The user can select any one of the audio-process functions and video-process functions, on the video/audio process function selection UI the display panel 205 displays. That is, the user can select at least one of video-process functions and at least one of audio-process functions he or she wants to incorporate in his or her digital television reception apparatus 10.

As shown in FIG. 2, the controller 201 controls the LAN interface 204, causing the same to download, from the server 30, the video/audio process program associated with the video-process and audio-process functions selected and also the setting menu corresponding to the process functions selected (Block 1003). Thus, the LAN interface 204 receives (downloads), form the server 30, the video/audio process program associated with the video-process and audio-process functions selected and also the setting menu corresponding to the process functions selected. The controller 201 then stores the setting menu in the memory 209. How the server 30 transmits the video/audio process programs and the setting menu corresponding to these programs will be described later.

The controller 201 controls the LAN interface 204, causing the same to transfer the video/audio process program, thus downloaded, to the digital television reception apparatus 10, to transmit a program-updating instruction to the digital television reception apparatus 10 (Block 1004). That is, the LAN interface 204 transmits the program-updating instruction, together with the video/audio process program to the digital television reception apparatus 10. In the digital television reception apparatus 10, the program updating processor 1017 updates the video process program stored in the nonvolatile memory 103, in accordance with the video/audio process program and program-updating instruction transmitted from the mobile terminal 20. Similarly, the program updating processor 1017 updates the audio process program stored in the nonvolatile memory 106. The video processing backend processor 104 processes the video process program transmitted from the mobile terminal 20 and now stored in the nonvolatile memory 103. Likewise, the audio processing backend processor 107 processes the audio process program transmitted from the mobile terminal 20 and now stored in the nonvolatile memory 106.

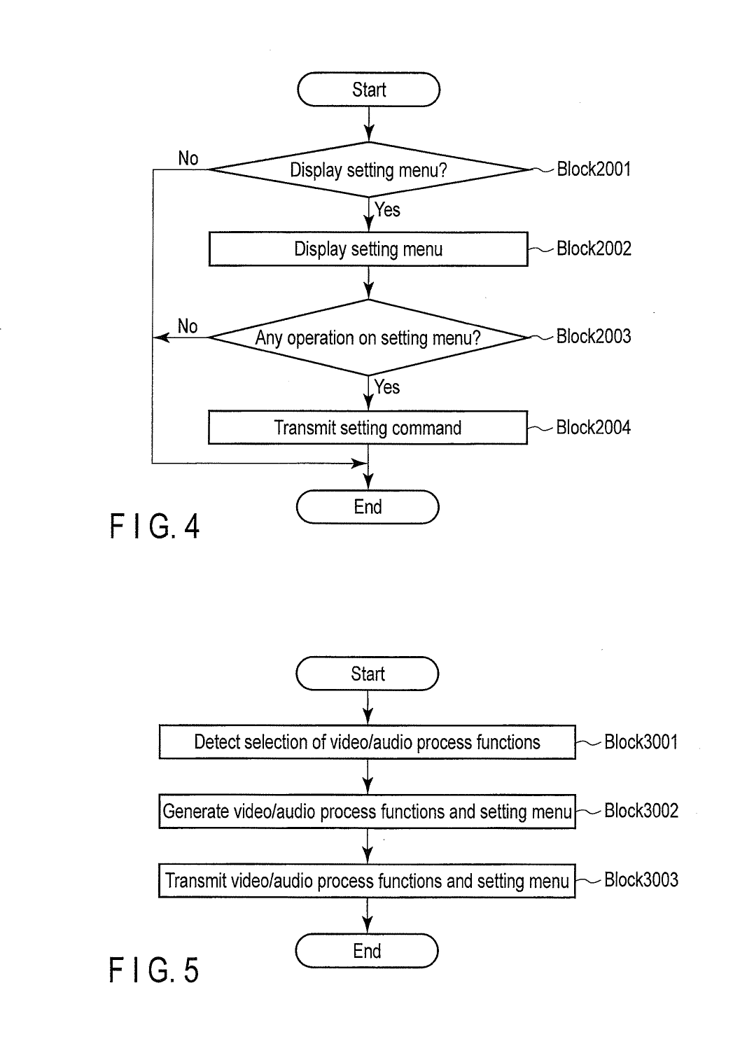

FIG. 4 is a flowchart explaining an exemplary process of setting the digital television reception apparatus 10 by using the setting menu input at the mobile terminal 20.

In the mobile terminal 20, the controller 201 determines whether the user has requested that the setting menu is displayed (Block 2001). After the user started viewing the image at the digital television reception apparatus 10, he or she may want to change the setting (e.g., on/off of functions and parameters) of the video/audio process program. In this case, the user inputs, on the display panel 205, a request for a setting menu that can set at least the programs to update.

If the user has not requested for the setting menu (NO in Block 2001), the controller 201 terminates the process of setting the digital television reception apparatus 10 by using the setting menu. If the user has requested for the setting menu (YES in Block 2001), the controller 201 controls the display panel 205, causing the same to display the setting menu (Block 2002). Then, the controller 201 determines whether the user has performed any operation on the setting menu (Block 2003). Note that the user can change, on the setting menu, the setting of any program that is changed.

If the user has not performed any operation on the setting menu (NO in Block 2003), the controller 201 terminates the process of setting the digital television reception apparatus 10 by using the setting menu. If the user has performed any operation on the setting menu (YES in Block 2003), the controller 201 control the LAN interface 204, causing the same to transmit a setting command to the digital television reception apparatus 10 (Block 2004). This setting command is data representing the changes made in the setting menu. Thus, the LAN interface 204 transmits this data representing the changes made in the setting menu, to the digital television reception apparatus 10. In the digital television reception apparatus 10, the video processing backend processor 104 changes the setting of the video process program in accordance with the setting command. Similarly, the audio processing backend processor 107 changes the setting of the audio process program. That is, the video processing backend processor 104 processes the video data in accordance with the video process program, and the audio processing backend processor 107 processes the audio data in accordance with the audio process program.

The main SoC 101 (more precisely, backend processor control processor 1016) merely outputs the setting command received at the LAN interface 1015, to the video processing backend processor 104 or the audio processing backend processor 107. That is, the setting command is not interpreted by the main SoC 101, but by either the video processing backend processor 104 or the audio processing backend processor 107. Therefore, the program for the main SoC 101 that performs the basic processing of the digital broadcast data is not updated in the digital television reception apparatus 10. Rather, only the video/audio process program for the video processing backend processor 104 or the audio processing backend processor 107 is updated, and the setting of the video process and audio process can be easily changed. Moreover, the embodiment, in which the mobile terminal 20 generates the setting menu, can be applied to any electronic apparatus that has audio process functions, but has no video process functions. In this respect, the embodiment is advantageous.

The mobile terminal 20 does not transmit the setting menu to the digital television reception apparatus 10, and neither the video/audio process program nor the setting menu is downloaded to the digital television reception apparatus 10 directly from the server 30. This is because the program the main SoC 101 uses must be written in order to enable the digital television reception apparatus 10 to handle the setting menu. If the program is rewritten, the digital television reception apparatus 10 will be degraded in terms of user friendliness.

FIG. 5 is a flowchart explaining an exemplary process that the server 30 performs to transmit the video/audio process program and the setting menu to the mobile terminal 20.

In the server 30, the controller 301 detects that the video/audio process functions selected on the on the video/audio process function selection UI of the mobile terminal 20 (Block 3001). The controller 301 generates the video/audio process program associated with combination of the video/audio process functions selected, and also the setting menu corresponding to the video/audio process program (Block 3002). The controller 301 then controls the LAN interface 304, causing the same to transmit, to the mobile terminal 20, the video/audio process program and the setting menu generated (Block 3003). That is, the LAN interface 304 transmits the video/audio process program and the setting menu to the mobile terminal 20 in accordance with the video/audio process functions the user has selected at the mobile terminal 20.

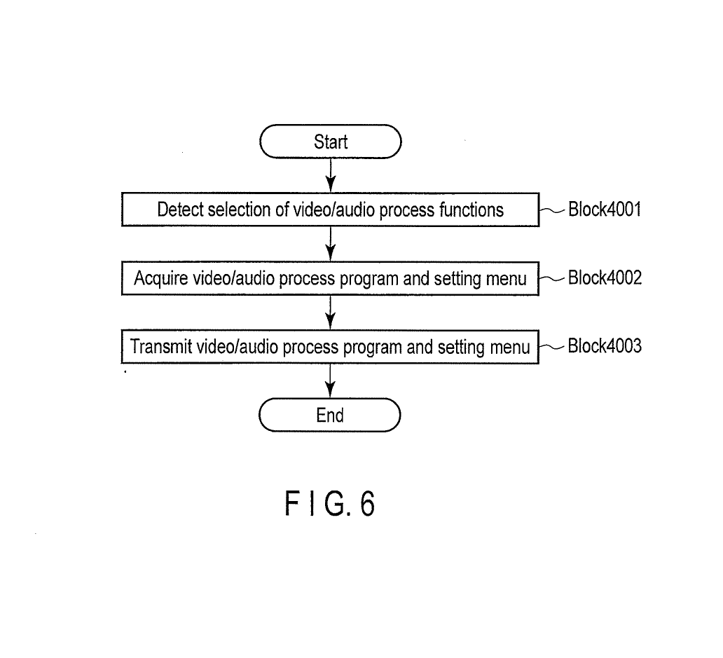

FIG. 6 is a flowchart explaining another exemplary process that the server 30 performs to transmit the video/audio process program and the setting menu to the mobile terminal 20.

In the server 30, the controller 301 detects that the video/audio process functions has been selected on the video/audio process function selection UI of the mobile terminal 20 (Block 4001). The controller 301 then acquires, from the memory 305, the video/audio process program associated with combination of the video/audio process functions selected, and also the setting menu corresponding to the video/audio process program (Block 4002). That is, the manager of the server 30 has prepared the video/audio process program associated with the video/audio process functions the user may select and also the setting menu corresponding to the video/audio process program, and has stored the video/audio process program and the setting menu in the memory 305. The controller 301 controls the LAN interface 304, causing the same to transmit, to the mobile terminal 20, the video/audio process program and the setting menu acquired from the memory 305 (Block 4003).

In the process of transmitting the video/audio process program and the setting menu to the mobile terminal 20, the server 30 need not generate the video/audio process program or the setting menu when the user selects video/audio process functions at the mobile terminal 20. As a result, the video/audio process program and the setting menu can be transmitted at a higher speed.

With the embodiment, the user can customize the video/audio process functions of the digital television reception apparatus 10 in accordance with his or her taste. If the user selects only one function he or she wants the digital television reception apparatus 10 to perform, the processor provided in the reception apparatus 10 can use all its capability to perform the function selected. The digital television reception apparatus 10 can therefore be customized to increase the image quality or sound quality.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing terminal comprising:
a selector configured to select at least one of functions to incorporate in a first external apparatus, in accordance with a user's operation;
a receiver configured to download, from a second external apparatus, a program associated with selected functions and a setting menu of the program; and
a transmitter configured to transmit the program and setting information representing a change in the setting menu to the first external apparatus.

2. (canceled)

3. The terminal of claim 1, further comprising a memory configured to store the setting menu.

4. (canceled)

5. The terminal of claim 1, wherein the selector is configured to select the functions on a user interface the second external apparatus provides.

6. The terminal of claim 1, wherein the transmitter is configured to transmit, to the first external apparatus, an instruction for updating the program, together with the program.

7. The terminal of claim 1, wherein the functions pertain to at least one of video-process functions and audio-process functions of a video processor and an audio processor, respectively, which are provided in the second external apparatus.

8. An information processing system comprising an information processing terminal, a server and an electronic apparatus,
the information processing terminal comprising:
a selector configured to select at least one of functions to incorporate in the electronic apparatus, in accordance with a user's operation;
a receiver configured to download, from the server, a program associated with selected functions and a setting menu of the program; and
a transmitter configured to transmit the program and setting information representing a change in the setting menu to the electronic apparatus,
the server comprising a transmitter configured to transmit the program to the information processing terminal in accordance with the selected functions at the information processing terminal, and
the electronic apparatus comprising a processor configured to process data in accordance with the program transmitted from the information processing terminal.

9. An information processing method comprising:
selecting at least one of functions to incorporate in a first external apparatus, in accordance with a user's operation;
downloading, from a second external apparatus, a program associated with selected functions and a setting menu of the program, and
transmitting the program and setting information representing a change in the setting menu to the first external apparatus.
